(19) United States
(12) Patent Application Publication
(10) Pub. No.: US 2026/0156708 A1
(43) Pub. Date: Jun. 4, 2026

(54) MOBILE COMMUNICATION NETWORK

(71) Applicant: KDDI CORPORATION, Tokyo (JP)

(72) Inventors: Souhei ITAHARA, Fujimino-shi (JP); Akito SUZUKI, Fujimino-shi (JP); Masaki SUZUKI, Fujimino-shi (JP); Masayuki KURATA, Fujimino-shi (JP)

(21) Appl. No.: 19/460,646

(22) Filed: Jan. 27, 2026

Related U.S. Application Data
(63) Continuation of application No. PCT/JP2024/007227, filed on Feb. 28, 2024.

(30) Foreign Application Priority Data
Aug. 1, 2023 (JP) 2023-125627

(51) Int. Cl. H04W 76/25; H04W 12/06; H04W 76/15

(52) U.S. Cl. CPC H04W 76/25; H04W 12/06; H04W 76/15

(57) ABSTRACT

A mobile communication network that communicates with a plurality of wireless devices belonging to a same group, includes a plurality of base stations, wherein the mobile communication network is configured to maintain a connection for the group between each of a plurality of first base stations among the plurality of base stations and a network node connected to an external network, and each of the plurality of first base stations stores a context of the group and an identifier of the context.

### CROSS-REFERENCE TO RELATED APPLICATION(S)

This application is a continuation of International Patent Application No. PCT/JP 2024/007227 filed on Feb. 28, 2024, which claims priority to and the benefit of Japanese Patent Application No. 2023-125627 filed on Aug. 1, 2023, the entire disclosures of which are incorporated herein by reference.

### BACKGROUND OF THE INVENTION

### Field of the Invention

The present disclosure relates to a mobile communication network.

### Description of the Related Art

To improve the accommodation efficiency of wireless devices (WDs) for machine-type communication (MTC), NPL 1 discloses a configuration in which such WDs are grouped and the same International Mobile Subscriber Identity (IMSI) is assigned to a plurality of WDs within the same group. Note that, in the following description, a wireless device for MTC is simply referred to as “WD”.

NPL 1: M. Ito, et al., “Reducing state information by sharing IMSI for cellular IoT devices”, IEEE IoT J., 2016

FIG. 1 is an explanatory diagram illustrating an outline of the configuration disclosed in NPL 1. WD #1 to WD #4 belong to the same group and therefore have the same IMSI. In FIG. 1, WD #1 and WD #2 are located within a cell provided by base station (BS) #1, and WD #3 and WD #4 are located within a cell provided by BS #2. BS #1 and BS #2 are connected to a core network.

For example, when data to be transmitted occurs at WD #1, WD #1 sends an RRC Connection Setup Request message including a Service Request message to BS #1. BS #1 forwards the Service Request message included in the RRC Connection Setup Request message to an Access and Mobility Management Function (AMF) in the core network. Triggered by this, a Protocol Data Unit (PDU) session between WD #1 and an User Plane Function (UPF) is established. Note that, for establishing the PDU session, control messages are exchanged between the AMF, a Session Management Function (SMF), and the UPF. After the PDU session is established, WD #1 transmits data via the PDU session. After the completion of data transmission, WD #1 transitions to the idle state.

Note that, since WD #1 to WD #4 share the same IMSI, WD #2 to WD #4 cannot perform communication when WD #1 is communicating. However, the communication frequency and communication duration of WDs for MTC are short, so the probability of communication collision is low.

However, in the configuration of NPL 1, when data to be transmitted occur at a WD, as described above, control messages must be exchanged among the BS, AMF, SMF, and UPF to establish a PDU session, resulting in a long delay from the occurrence of data to its actual transmission.

### SUMMARY OF THE INVENTION

According to an aspect of the present disclosure, a mobile communication network that communicates with a plurality of wireless devices belonging to a same group, includes a plurality of base stations, wherein the mobile communication network is configured to maintain a connection for the group between each of a plurality of first base stations among the plurality of base stations and a network node connected to an external network, and

each of the plurality of first base stations stores a context of the group and an identifier of the context.

Further features of the present disclosure will become apparent from the following description of exemplary embodiments with reference to the attached drawings.

### BRIEF DESCRIPTION OF THE DRAWINGS

FIG. 1 is an explanatory diagram of the background art.

FIG. 2 is a configuration diagram of a mobile communication network according to an embodiment.

FIG. 3 is an explanatory diagram of information stored in WDs and BSs.

FIG. 4 is a sequence diagram for a case where data to be transmitted occurs at a WD.

FIG. 5 is a configuration diagram for establishing an N3 tunnel between a BS and a UPF.

FIG. 6 is a sequence diagram for establishing an N3 tunnel between a BS and a UPF.

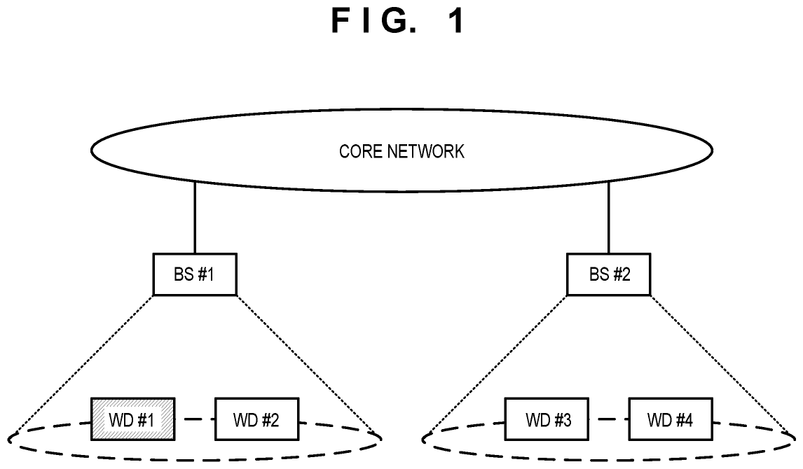

### DESCRIPTION OF THE EMBODIMENTS

The embodiments are described in detail below with reference to the accompanying drawings. The following embodiments do not limit the invention of the claims, and not all of the combinations of features described in the embodiments are essential to the invention. Two or more of the features described in the embodiments may be arbitrarily combined. The same reference numeral is used for the same or similar element, and duplicated explanations are omitted.

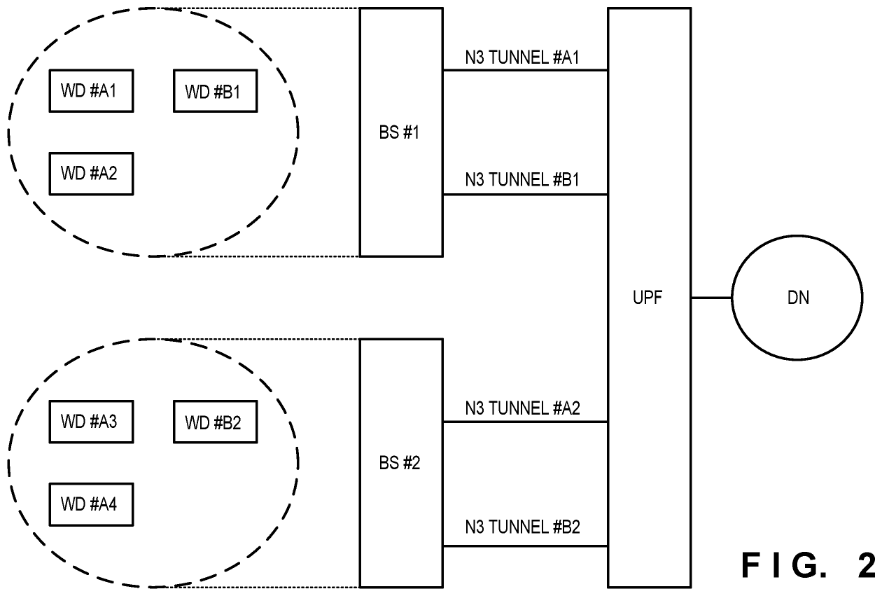

FIG. 2 is an explanatory diagram of a mobile communication network according to the present embodiment. In FIG. 2, WDs #A1, #A2, #A3, and #A4 belong to the same Group #A and have the same IMSI #A. Furthermore, in FIG. 2, WDs #B1 and #B2 belong to the same Group #B and have the same IMSI #B. According to FIG. 2, WDs #A1 and #A2 as well as WD #B1 are located within a cell provided by BS #1, while WDs #A3 and #A4 as well as WD #B2 are located within a cell provided by BS #2. WDs #A1 to #A4 and WDs #B1 and #B2 may be wireless devices for machine-type communication (MTC) or Internet of Things (IoT) devices. Groups are determined by the operator providing services using each WD or based on service content or the like. For example, Group #A may be a group of wireless devices attached to electric meters for reporting electricity usage, and Group #B may be a group of wireless devices attached to gas meters for reporting gas usage. Groups may also be classified by area, such as Kanto or Kansai areas.

In the present embodiment, each WD belonging to a group is configured to transition between a connected state (RRC_CONNECTED) and an inactive state (RRC_INACTIVE) but not transition to an idle state (RRC_IDLE). Note that, in FIG. 2, all of WDs #A1 to #A4 belonging to Group #A and WDs #B1 and #B2 belonging to Group #B are assumed to be in the inactive state.

Corresponding to not transitioning the WDs belonging to a group to the idle state, the mobile communication network establishes and maintains an N3 tunnel for each group between the UPF and each BS. Note that the N3 tunnel is a “connection” established in a section between the UPF, which connects to a Data Network (DN), and the BS within a PDU session. Note that the UPF is a network node in the user plane, and the DN is an external network, such as the Internet, as viewed from the mobile communication network. According to FIG. 2, N3 tunnel #A1 is used for a PDU session of WDs #A1 and #A2 of Group #A camping in the cell, which is an area served by BS #1, and N3 tunnel #B1 is used for a PDU session of WD #B1 of Group #B camping in the cell provided by BS #1. Similarly, N3 tunnel #A2 is used for a PDU session of WDs #A3 and #A4 of Group #A camping in the cell provided by BS #2, and N3 tunnel #B2 is used for a PDU session of WD #B2 of Group #B camping in the cell provided by BS #2.

Although BS #1 and BS #2 establish N3 tunnels with the same UPF in FIG. 2, the UPF that establishes an N3 tunnel may differ for each BS. That is, the UPF that establishes N3 tunnel #A1 with BS #1 and the UPF that establishes N3 tunnel #A2 with BS #2 may be different. Furthermore, the UPF that sets the N3 tunnel may differ for each group. For example, the UPF that establishes N3tunnel #A1 with BS #1 and the UPF that establishes N3 tunnel #B1 with BS #1 may be different.

When a WD transitions from the connected state to the inactive state, the BS (last BS) connected to the WD notifies the WD of an Inactive-Radio Network Temporary Identifier (I-RNTI) and a Message Authentication Code-Integrity (MAC-I) and stores the user equipment (UE) context of the WD. The WD in the inactive state stores the I-RNTI and MAC-I.

The I-RNTI is a combination of the WD identifier and the last BS identifier. Furthermore, the MAC-I is an authentication code generated based on the UE context, which is maintained at the last BS, of the WD. When the WD transitions from the inactive state to the connected state, it sends an RRC Resume Request including the MAC-I and I-RNTI to a BS. The BS receiving the RRC Resume Request determines the last BS based on the I-RNTI, and obtains the UE context of the WD from the last BS. Then, the BS receiving the RRC Resume Request authenticates the WD based on the obtained UE context and the MAC-I received from the WD.

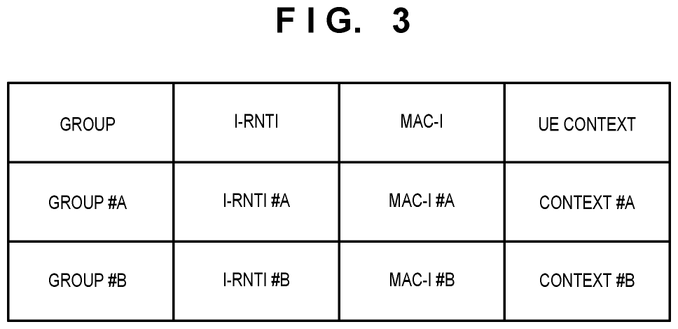

In the present embodiment, a UE context for a plurality of WDs belonging to the same group and an I-RNTI for identifying the UE context are predetermined. Furthermore, based on the UE context determined for the group, a MAC-I for the group is obtained. For example, as shown in FIG. 3, for Group #A, Context #A is generated as a UE context, I-RNTI #A is assigned as the I-RNTI identifying Context #A, and MAC-I #A is generated based on Context #A. Similarly, for Group #B, Context #B is generated as a UE context, I-RNTI #B is assigned as the I-RNTI identifying Context #B, and MAC-I #B is generated based on Context #B.

Then, MAC-I #A and I-RNTI #A are stored in WDs #A1 to #A4 belonging to Group #A in advance, and MAC-I #B and I-RNTI #B are stored in WDs #B1 and #B2 belonging to Group #B in advance.

Furthermore, in BSs #l and #2 that provide service to the cells (areas) where WDs #A1 to #A4 belonging to Group #A are located, the Context #A of Group #A is stored in association with I-RNTI #A, which is the identifier of the Context #A. Similarly, in BSs #1 and #2 that provide service to the cells (areas) where WDs #B1 and #B2 belonging to Group #B are located, the Context #B for WDs of Group #B is stored in association with I-RNTI #B, which is the identifier of the Context #B.

In summary, the mobile communication network always maintains an N3 tunnel for a group, which connects the BS where WDs belonging to the group are located within its cell and the UPF, and stores the UE context of the group in the BS where WDs belonging to the group are located within its cell, associating it with the group's I-RNTI. In addition, each WD belonging to the group stores the group's I-RNTI and MAC-I.

Note that, in the present embodiment, the BS in which WDs belonging to the group are located within its cell stores the UE context and I-RNTI of the group and establishes an N3 tunnel. However, for example, in consideration of the addition or movement of WDs belonging to the group, it is possible to adopt a configuration in which the BSs where WDs of the group are not located within their cells also store the UE context and I-RNTI of the group and have an N3 tunnel established in advance. In other words, the BSs that establish an N3 tunnel for the group and store the UE context and I-RNTI of the group include at least the BS that provides service to the cell where WDs belonging to the group are located, but may additionally include BSs where no WDs of the group are located within their cells. The BSs that establish an N3 tunnel for the group and store the group's UE context and I-RNTI may be determined based on the service area for services (e.g., metering) provided by the WDs of the group.

As described above, the I-RNTI is originally generated based on the identifier of the WD and the identifier of the last BS. However, in the present embodiment, the I-RNTI may be generated independently of the identifiers of the WDs and BSs. That is, the BS treats the I-RNTI received from a WD belonging to the group as indicating that the UE context is stored in the BS, and does not perform processing such as determining the last BS based on the received I-RNTI. The group I-RNTI is determined so that it does not overlap with a normal I-RNTI, which is typically generated based on the identifiers of the WD and the last BS. Furthermore, the group I-RNTI may be configured so that, from its value, the BS can determine that it is a group I-RNTI rather than an I-RNTI generated based on the WD and last BS identifiers.

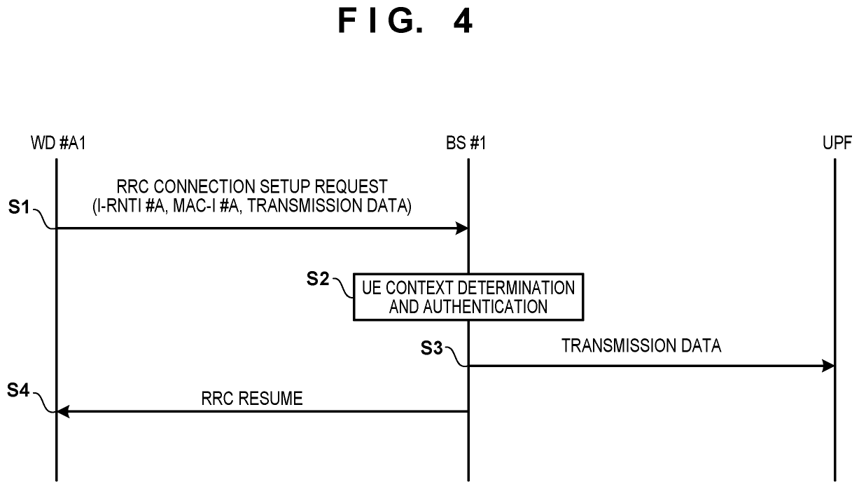

FIG. 4 is a sequence diagram illustrating the case where transmission data occurs in WD #A1 of FIG. 2. In step S1, WD #A1 sends an RRC Connection Setup Request message to BS #1. The RRC Connection Setup Request message includes I-RNTI #A and MAC-I #A stored in WD #A1, along with the transmission data. In response to the RRC Connection Setup Request message, BS #1 determines, in step S2, Context #A as the UE context of WD #A1 based on I-RNTI #A, and authenticates WD #A1 based on Context #A and MAC-I #A. Here, authentication is assumed to be successful. In this case, in step S3, BS #1 uses N3 tunnel #A1 to forward the transmission data to the UPF and, in step S4, sends an RRC Resume message to WD #A1.

The sequence in FIG. 4 is basically the same as the sequence defined by 3GPP for transitioning from the inactive state to the connected state. The difference is that, in step S2, BS #1 determines the UE context stored in BS #1 based on I-RNTI #A, without determining the last BS based on I-RNTI #A.

As is clear from the sequence in FIG. 4, in the present embodiment, when a WD transmits data, there is no need for control signaling exchanges involving the BS, AMF, SMF, and UPF. Accordingly, it is possible to suppress an increase in the time from when data to be transmitted occurs in the WD until the data is actually transmitted.

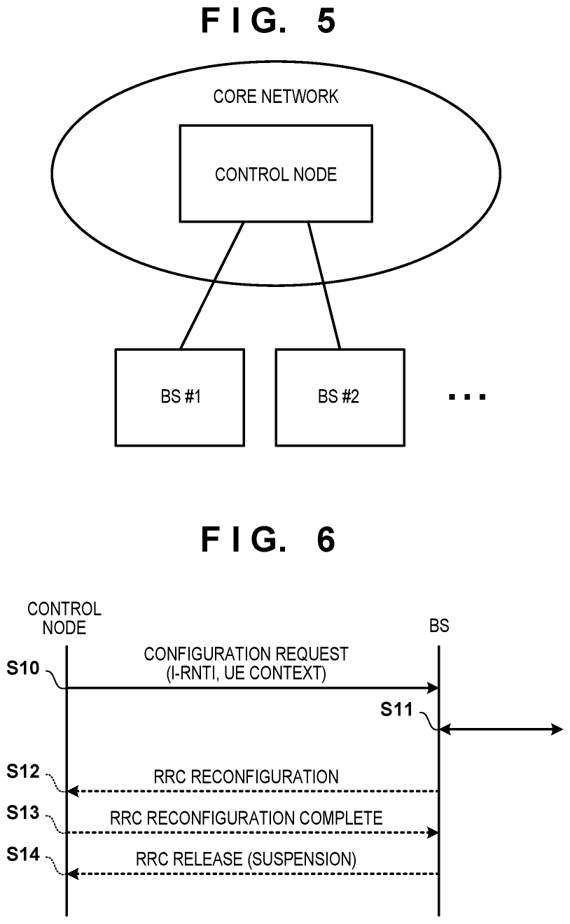

As described above, in the present embodiment, an N3 tunnel for the group is pre-established in the BSs within the service area, and the UE context and I-RNTI for the group are stored in the BSs in advance. Accordingly, in the present embodiment, the core network of the mobile communication network includes a control node as shown in FIG. 5. The control node stores the group's I-RNTI and UE context and is provided with information identifying the BSs that establish the N3 tunnel.

FIG. 6 is a sequence diagram illustrating the process of establishing an N3 tunnel between the BS and the UPF and storing the group's I-RNTI and UE context in the BS. Note that FIG. 6 shows the procedure for a single BS. The control node performs the process shown in FIG. 6 for each BS that establishes an N3 tunnel.

In step S10, the control node sends a configuration request message to the BS. The configuration request message includes the UE context and I-RNTI to be stored in the BS. In response to receiving the configuration request message, the BS sends, in step S11, a request to the AMF to establish a PDU session. As a result, the AMF, SMF, and UPF exchange control signaling to establish the N3 tunnel. The BS also stores the UE context and I-RNTI. When the establishment of the N3 tunnel section is completed, the BS sends an RRC Reconfiguration message to the control node in step S12. The control node, in response to the RRC Reconfiguration message, transmits an RRC Reconfiguration Complete message to the BS in step S13. The processing in steps S11 to S13 is basically the same as the procedure for establishing a PDU session for a WD. The difference is that the control node, acting as a WD, sends the UE context and I-RNTI to be stored in the BS to the BS.

Subsequently, in step S14, the BS sends an RRC Release message including information indicating suspension to the control node. The processing in S14 is also similar to the procedure performed by the BS to transition a WD from the connected state to the inactive state. The difference is that, in the RRC Release message, it is not necessary to notify the UE of the I-RNTI and MAC-I.

Note that the purpose of the sequence in FIG. 6 is to establish an N3 tunnel between the BS and the UPF and to store the group's I-RNTI and UE context in the BS. Therefore, the processing in steps S12 to S14 of FIG. 6 may be omitted.

Each WD belonging to the group stores the group's I-RNTI and MAC-I in advance. This can be done at any timing prior to using the WD for service, such as before shipment or immediately before service activation, and by any method. For example, the MAC-I of the group may also be stored in the control node, and the configuration may be such that the control node transmits the MAC-I and the I-RNTI of the group to each WD of the group that is configured to communicate with the control node.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

What is claimed is:

1. A mobile communication network that communicates with a plurality of wireless devices belonging to a same group, comprising a plurality of base stations, wherein
the mobile communication network is configured to maintain a connection for the group between each of a plurality of first base stations among the plurality of base stations and a network node connected to an external network, and
each of the plurality of first base stations stores a context of the group and an identifier of the context.

2. The mobile communication network according to claim 1, wherein the plurality of wireless devices are configured to be in an inactive state when not communicating and to transition to a connected state when communicating.

3. The mobile communication network according to claim 2, wherein the plurality of wireless devices are configured not to transition to an idle state.

4. The mobile communication network according to claim 1, wherein the plurality of wireless devices are machine-type communication devices or Internet of Things (IoT) devices.

5. The mobile communication network according to claim 1, wherein the network node is a node that implements a User Plane Function.

6. The mobile communication network according to claim 1, wherein the connection is an N3 tunnel.

7. The mobile communication network according to claim 1, wherein the plurality of first base stations include at least a base station that provides service to an area where the plurality of wireless devices are located, among the plurality of base stations.

8. The mobile communication network according to claim 1, wherein
each of the plurality of wireless devices has the identifier of the context of the group and an authentication code generated based on the context of the group, and
the plurality of first base stations is configured such that, when receiving transmission data, the identifier, and the authentication code from a first wireless device among the plurality of wireless devices, the plurality of first base stations determines, based on the identifier, the context of the group to which the first wireless device belongs, authenticates the first wireless device based on the determined context and the authentication code, and, upon successful authentication, transmits the transmission data on the connection.

9. The mobile communication network according to claim 1, further comprising a control node configured to notify each of the plurality of first base stations of the context of the group and the identifier of the context, and to establish the connection between each of the plurality of first base stations and the network node.
